(19) United States
(12) Patent Application Publication
(10) Pub. No.: US 2016/0259592 A1
(43) Pub. Date: Sep. 8, 2016

(54) DATA STORING CONTROL APPARATUS AND METHOD

(71) Applicant: FUJITSU LIMITED, Kawasaki-shi (JP)

(72) Inventor: Toshiaki SAEKI, Kawasaki (JP)

(73) Assignee: FUJITSU LIMITED, Kawasaki-shi (JP)

(21) Appl. No.: 15/012,948

(22) Filed: Feb. 2, 2016

(30) Foreign Application Priority Data
Mar. 2, 2015 (JP) 2015-040775

(51) Int. Cl. G06F 3/06

(52) U.S. Cl. CPC G06F 3/0644; G06F 3/0604; G06F 3/0629; G06F 3/0683

(57) ABSTRACT

A data storing control apparatus includes a processor. The processor executes a process including: selecting any of groups stored in a second storage unit when an empty space of the second storage unit configured to store data obtained from a first storage unit becomes insufficient; partitioning the selected group in accordance with a state of access to data corresponding to a data access request in the second storage unit among data included in the selected group; and storing data respectively included in the groups in the first storage unit in units of the groups obtained by being partitioned.

### CROSS-REFERENCE TO RELATED APPLICATION

This application is based upon and claims the benefit of priority of the prior Japanese Patent Application No. 2015-040775, filed on Mar. 2, 2015, the entire contents of which are incorporated herein by reference.

### FIELD

The embodiments discussed herein are related to a technique for controlling storing of data.

### BACKGROUND

In a storage device, a throughput of an irregular access to small-sized data is low, and the cost of a random access is higher than the cost of a sequential access. As techniques for improving the throughput, cache techniques are presented.

The cache techniques are techniques for reducing the length of processing time by using a memory when a control apparatus having a high processing speed reads data faster from a low-speed storage device. When the control apparatus reads data from a low-speed storage device, the read data is temporarily stored in a memory, so that the data can be read from the memory, from and to which the data can be read and written faster than a hard disk, at second and subsequent times. For example, Patent Documents 1 to 3 are related to such cache techniques.

One of the cache techniques is a Least Recently Used (LRU) cache technique. A fundamental algorithm of the LRU cache technique is such that data that has remained unused for the longest duration among data stored in a high-speed storage device having a small capacity (such as a cache memory) is stored in a low-speed storage device (such as a main storage device) having a large capacity when the high-speed storage device becomes full. The LRU cache technique is an algorithm with which advantageous effects can be achieved even if the logic of an application program is not known, and the advantageous effects are achieved only when the same data is repeatedly accessed in a short time (while data is held in a cache). A cache lifetime is decided in accordance with the capacity of a cache memory. The LRU cache technique is not effective in accesses repeatedly performed in a cycle that exceeds the cache lifetime.

As a technique implemented by improving the LRU cache technique, there is a data management method executed by a data management apparatus that includes a first storage unit configured to store data, and a second storage unit which is a relationship storage unit to which an access can be performed faster than the first storage unit and is configured to store data (for example, Patent Document 1). The data management apparatus reads, from the first storage unit or the second storage unit, data corresponding to an input data request, and outputs the read data. The data management apparatus analyzes a relationship between data stored in the first storage unit and the second storage unit on the basis of a history of input data requests. The data management apparatus classifies the data stored in the first storage unit or the second storage unit into groups on the basis of results of the analysis. The data management apparatus stores the data in the second data storage unit for each of the classified groups. Thus, the requested data can be quickly output.

Patent Document 1: Japanese Laid-open Patent Publication No. 2000-357125

Patent Document 2: Japanese Laid-open Patent Publication No. 2000-250809

Patent Document 3: Japanese Laid-open Patent Publication No. 2002-251322

Patent Document 4: International Publication Pamphlet No. 2013/114538

### SUMMARY

According to an aspect of the embodiment, a data storing control apparatus includes a processor. The processor executes a process including: selecting any of groups stored in a second storage unit when an empty space of the second storage unit configured to store data obtained from a first storage unit becomes insufficient; partitioning the selected group in accordance with a state of access to data corresponding to a data access request in the second storage unit among data included in the selected group; and storing data respectively included in the groups in the first storage unit in units of the groups obtained by being partitioned.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A to 1D are explanatory diagrams of a problem caused by a group size in a data rearrangement technique.

FIG. 2 illustrates an example of a data storing control apparatus according to an embodiment.

FIG. 3 illustrates an example of a hardware configuration of the data management apparatus according to the embodiment.

FIG. 4 illustrates a configuration example of functions of the data management apparatus according to this embodiment.

FIG. 5 is an explanatory diagram of a data structure in this embodiment.

FIG. 6 illustrates a group management table and a relationship storage table when an access request Rq has been issued to the data management apparatus according to the embodiment.

FIG. 7 illustrates the group management table and the relationship storage table when an access request Rq has been issued to the data management apparatus, subsequently to the state of FIG. 6.

FIG. 8 illustrates the group management table and the relationship storage table when an access request Rq has been issued to the data management apparatus, subsequently to the state of FIG. 7.

FIG. 9 illustrates group arrangements before and after a relationship analysis unit changes groups in the state illustrated in FIG. 8.

FIG. 10 illustrates an association between data after being changed by a group arrangement unit and a group in the group management table.

FIG. 11 illustrates the group management table and the relationship storage table when a plurality of access requests Rq have been issued to the data management apparatus, subsequently to the state of FIG. 10.

FIG. 12 illustrates the group management table and the relationship storage table when an access request Rq has been issued to the data management apparatus, subsequently to the state of FIG. 11.

FIG. 13 illustrates group arrangements before and after the relationship analysis unit decides groups in the state of FIG. 12.

FIG. 14 is one example of a flowchart that represents a flow of the entire process executed by the data management apparatus according to this embodiment when an access request has been issued.

FIG. 15 is one example of a flowchart that represents a relationship analysis process executed by the relationship analysis unit.

FIG. 16 is an explanatory diagram of a process for partitioning a group to be rewritten in accordance with the size of the group to be rewritten when data is rewritten from a memory device to a storage device in this embodiment.

FIG. 17 is a flowchart that represents a flow of a process executed when any of the groups stored in the memory device is rewritten to the storage device in this embodiment.

FIG. 18 is a flowchart that represents details of a group partitioning process in this embodiment.

### DESCRIPTION OF EMBODIMENTS

With the above described data management technique, however, when a group size as the unit of a rewrite increases to too large a value, a cost needed to read the entire group increases, leading to a degradation in access performance.

Inversely, when the group size is decreased to too small a value, particular data and data related to the particular data are not included in the same segment. This causes extra accesses to occur. As a result, the access performance is degraded.

Additionally, with the above described data management technique, data incorporated into the same segment is determined on the basis of a relationship obtained from an access pattern. However, when a relationship is used to decide a segment size, it is needed to use not a relationship of individual pieces of data (whether there is a relationship) but the positioning of a relationship of individual pieces of data relative to a relationship of all of the data. However, the above described technique does not take this into account.

In one aspect of the present invention, a technique for preventing a degradation of access performance due to an increase in the size of a write to a storage unit is provided.

One of the data management methods is, for example, a data rearrangement management technique (hereinafter referred to as DLM) used in Patent Document 4. Operations of the DLM include the following. With the DLM, related data are merged into a group, and stored as consecutive areas in a storage device. With the DLM, data is read in units of groups to which data belongs and is cached in a memory when an access is made to the data. It is expected that only one random access will be required as an access to the group. As for a group, the size of the group becomes larger than the size of a single piece of data. Therefore, an access cost increases. However, an increment in the access cost is slight in comparison with the cost of a random access. With the DLM, when the space of the memory becomes insufficient, a group is rewritten to a disk in order of less-accessed groups. With the DLM, when data is rewritten, it is rewritten from the memory to a disk in units of groups by using an LRU method.

By utilizing the DLM technique, data included in a group that is cached in a memory can be accessed without an additional storage access cost until the group is rewritten to a disk. Namely, even if accesses are made to any number of pieces of data in a group, the cost needed for the accesses to the group is only that needed for one access made to the data (this is because an increment in the access cost due to an increase in the data size is slight). Namely, the DLM technique achieves advantageous effects when accesses are made to data that belong to the same group in a short time. Accesses may be made to different data, unlike the LRU. Namely, advantageous effects such as those achieved by a prefetch cache can be obtained. Similarly to the LRU, the DLM technique can achieve advantageous effects even if the logic of an application is not known.

Here, the number of pieces of data within a group to which accesses are made while the group is cached in the memory is referred to as “the number of data reuses”. Note that, however, the number of times that accesses are made to the same data is not counted. In this embodiment, the number of pieces of different data to which accesses are made is counted.

As described above, with AL, data is stored as a group of data clusters in data storing with which a large amount of data can be stored. With the DLM, an access pattern is analyzed for each access to data, and data having a close relationship (data accessed almost simultaneously) in an access pattern are stored in the same group. Thus, with the DLM, data having a close relationship can be read at one time from a low-speed data storage device to a high-speed data storage device, whereby data accesses can be made efficient.

Additionally, the cost of a random access is the cost needed for one access made per group. Accordingly, if data that are accessed at a close timing with a high probability (a relationship of an access pattern) can be successfully merged into the same group by being rearranged, the cost of a random access can be significantly reduced.

The DLM can achieve significant advantageous effects when most pieces of data are as small as several bytes to several K bytes.

However, the DLM has the following problems.

Problem 1: Too Large a Group Size

When a group, the unit of a read or a write from or to a storage, becomes too large, the cost becomes higher (than the cost of a read or write from or to a single piece of data). Therefore, performance is degraded (even if the advantageous effects achieved by DLM are taken into account). The reason is as follows. If the size of a group increases, the access cost also increases. Therefore, a threshold value of the number of data reuses for getting a payback for the access cost increases.

Here, the access cost is a cost obtained by adding a varying cost that depends on a size to the fixed cost of a random access. The cost that depends on a size is low in comparison with the cost of a random access. However, it is not so low as to be totally ignorable.

The number of data reuses cannot exceed a threshold value unless it is an ideal access pattern in which the number of data reuses is large. Since an access pattern depends on the logic of an application and can vary, it is not always an ideal access pattern. As the threshold value increases, a ratio of access patterns that can exceed the threshold value decreases.

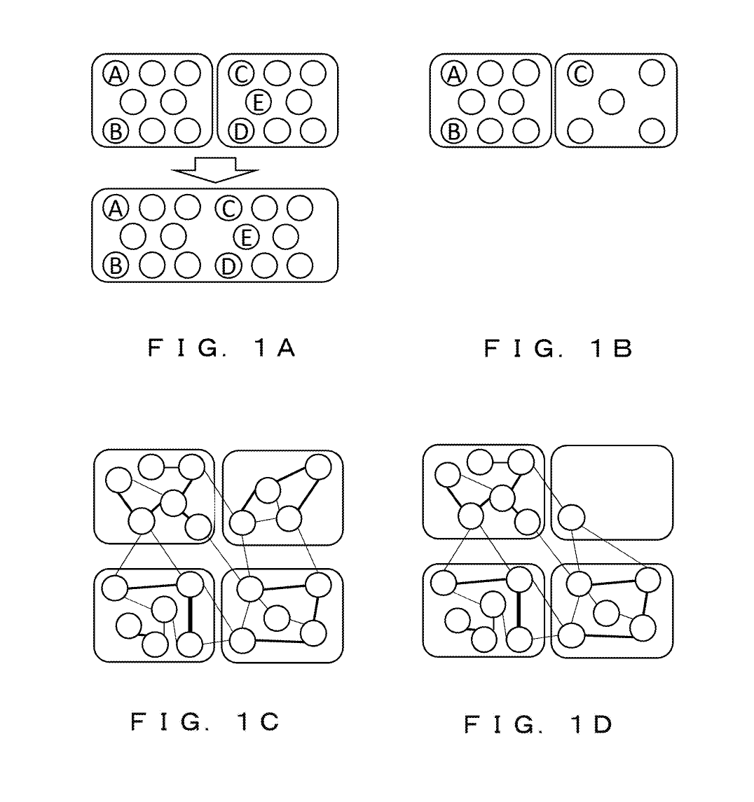

Characteristics of the performance of the DLM are described by using the following assumptions and FIGS. 1A to 1D.

FIG. 1A is an explanatory diagram of a problem caused by too large a group size.

### (Access Cost)

Assume that the cost of a random access is 10.

Assume that the sizes of individual pieces of data are the same and the cost of an access to the individual pieces of data is 11 (the cost derived from the size is assumed to be 1).

Assume that the cost of an access to a small group is 20 and the cost of an access to a large group is 30.

### (Relationship)

Assume that a relationship between A and B is 100 percent, namely, that A and B are always accessed as a set.

Assume also that a relationship between C and D is 100 percent.

There is also a relationship between {A,B} and {C,D}, and this relationship is changed.

Assume that data other than A to D are present but no accesses are made to the data at this time.

### (Analysis)

(1) A Case where Accesses are Made Only to {A, B} (a Relationship Between {A,B} and {C,D} is 0 Percent).

With the LRU, the cost is 11×2=22. In the meantime, when {A,B} are arranged in a small group with the DLM, the cost is 20. When {A,B} are arranged in a large group with the DLM, the cost is 30.

Namely, the order of the cost is DLM small group<LRU<DLM large group, and the DLM large group becomes higher than that needed with the LRU by 50 percent.

(2) A Case where a Relationship Between {a,B} and {C,D} is 25 Percent

With the LRU, the cost is 11×2+0+0.25×11×2=27.5. In the meantime, with the DLM (small group), the cost is 20+0.25×20=25. With the DLM (large group), the cost is 30.

Namely, the order of the cost is DLM small group<LRU<DLM large group, and the DLM large group becomes higher than that needed with the LRU by 9 percent.

(3) A Case where a Relationship Between {A,B} to {C,D} is 50 Percent

With the LRU, the cost is 11×2+0.5×11×2=33. In the meantime, with the DLM (small group), 20+0.5×20=30. With the DLM (large group), the cost is 30.

Namely, the order of the cost is DLM small group=DLM large group<LRU.

(4) A Case where Accesses are Always Made to {A,B} and {C,D} (a Relationship Between {A,B} and {C,D} is 100 Percent)

With the LRU, the cost is 11×4=44. In the meantime, when {A,B} and {C,D} are respectively arranged in small groups with the DLM, the cost is 40. Alternatively, when {A,B} and {C,D} are arranged in one large group with the DLM, the cost is 30.

Namely, the order of the cost is DLM large group<DLM small group<LRU.

Therefore, in accordance with the above described (1) to (4), the access cost of a group that is needed with the DLM becomes a risk factor. Accordingly, performance attained by the DLM sometimes becomes lower than that attained by the LRU depending on a relationship if the size of the group is too large.

Inversely, when the size of the group is too small, data that have a relationship cannot be fully stored in a group, so that the performance is not sufficiently improved. This is described with reference to FIG. 1B.

FIG. 1B is an explanatory diagram of the problem caused by a too small a group size. It is assumed that the size of a group has an upper limit, and a group of FIG. 1B to which {A,B} belongs is already filled with data.

Since a relationship of C with {A,B} is close, it is desired that the data be stored in the same group. However, the data cannot be stored because the group is already filled with the data.

Additionally, with the DLM, data to be partitioned into groups (data to be rearranged) are decided on the basis of a relationship between data obtained from an access pattern. However, when a relationship between data is used to decide the size of a group, not a relationship of individual pieces of data but the positioning of a relationship in all the pieces of data needs to be used. However, it is difficult to perform such operations in an algorithm of the DLM. This is described with reference to FIG. 1C.

FIG. 1C is an explanatory diagram of a grouping algorithm, and a problem caused by the size of a group. In FIG. 1C, data having a relationship are indicated with a line. In particular, a close relationship is indicated with a thick line. Moreover, data having a close relationship that is equal to or higher than a specified threshold value are respectively merged into groups.

Almost all the pieces of data have a certain degree of a relationship. Some pieces of data have a close relationship, while other pieces of data have a distant relationship.

When an attempt is made to simply merge all the pieces of data having a relationship into the same group, they are merged into one group.

It is preferable to classify only data that have a relatively close relationship into a group from the overall viewpoint. In this case, however, it is needed to grasp the degrees of closeness of all the relationships. It is difficult to grasp the degrees of closeness of all the relationships on the basis of a throughput of a limited number of memory storage accesses.

In FIG. 1C, data having a distant relationship are ignored, and other data are classified into groups. However, when only a portion of data or relationships can be found, it is difficult to detect a threshold value of an ignorable degree of a relationship.

Even if an upper limit of a group size is set to a fixed value, this poses a problem as illustrated in FIG. 1D.

FIG. 1D is an explanatory diagram of the problem that can occur when the upper limit of a group size is set. FIG. 1D assumes a case where data of an upper right group is captured into an upper left group so that the groups can be merged into the same group.

Here, however, the upper limit of each group size is set to six pieces of data. Therefore, the data of the upper right group cannot be captured unless any of the pieces of data is released from the upper left group. Actually, since all the pieces of data in the upper left group have a close relationship, it is easier to improve the performance by capturing the upper right group even if the size of the upper left group exceeds the upper limit.

There is also the following problem. When a group size is increased to improve the number of reuses, a cost needed to read a group is also increased. Therefore, the performance is not improved. Moreover, even though it is effective to increase a duration during which a group is held in the memory by expanding a memory to improve the number of reuses, the memory costs are high. Moreover, when a rearrangement is more actively performed to improve the number of reuses, an algorithm of the rearrangement is complicated, and the number of reuses cannot be increased with ease. Also the rearrangement has a cost, and the performance cannot be simply improved. In particular, the rearrangement in a range where the access cost of a hard disk drive (HDD) is not increased has a limitation. Moreover, when a group size is reduced, this also decreases the number of reuses. Accordingly, the performance is not simply improved.

Therefore, with the DLM according to the this embodiment, when the group is read from an HDD and is held as a cache in the memory, referenced pieces of data are marked and the number of marked pieces of data in the group is counted.

Additionally, with the DLM according to this embodiment, the following process is executed when a group is rewritten to an HDD. Namely, with the DLM, an optimum group size is calculated on the basis of the number of reuses. With the DLM, when the size of a group exceeds an optimum group size, the group is partitioned into a plurality of groups, and data is rewritten to an HDD so that the sizes of the groups can become smaller than the optimum group size. With the DLM, a huge amount of standalone data of a size that exceeds the optimum group size is partitioned into independent groups and stored when being rewritten to a disk. With the DLM, when the size of the group does not exceed the optimum group size, the group is rewritten to a disk as usual.

Details of this embodiment are described below.

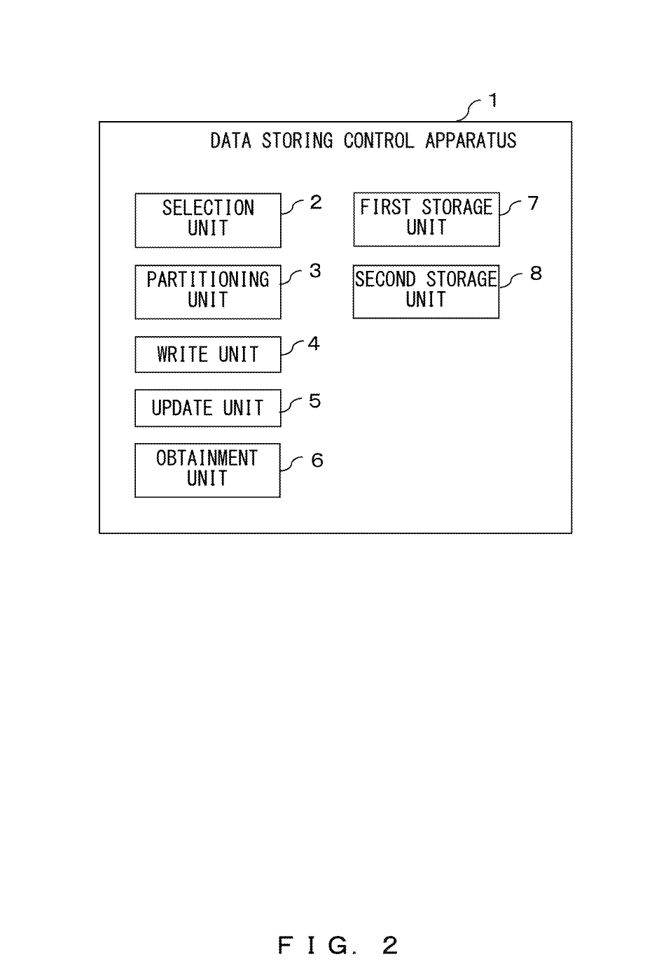

FIG. 2 illustrates one example of a data storing control apparatus according to this embodiment. The data storing control apparatus 1 includes a selection unit 2, a partitioning unit 3, a write unit 4, a first storage unit 7 and a second storage unit 8.

In a case where an empty space of the second storage unit 8 that is configured to store data obtained from the first storage unit 7 becomes insufficient, the selection unit 2 selects any of the groups stored in the second storage unit 8. The case where the empty space becomes insufficient is, for example, a case where data corresponding to an accepted data request is not held in the second storage unit 8, or a case where the amount of data stored in the second storage unit 8 exceeds a predetermined threshold value. As one example of the selection unit 2, an input/output management unit 21 can be cited. As one example of the first storage unit 7, a storage device 40 can be cited. As one example of the second storage unit 8, a memory device 30 can be cited.

The partitioning unit 3 partitions a selected group in accordance with a state of an access to data corresponding to a data access request among data included in the selected group in the second storage unit 8. As one example of the partitioning unit 3, a partitioning management unit 26 can be cited.

The write unit 4 stores data respectively stored in groups in the first storage unit 7 in units of the groups obtained by being partitioned. As one example of the write unit 4, a rewrite unit 27 can be cited.

With such a configuration, access performance can be prevented from being degraded by an increase in the size of a write to the first storage unit 7.

The data storing control apparatus 1 further includes an update unit 5 and an obtainment unit 6.

The update unit 5 updates group management information that makes an association between data and a group on the basis of results of partitioning. As one example of the update unit 5, a partitioning management unit 26 can be cited. As one example of the group management information, a group management table 30A can be cited.

When the data corresponding to the data access request is not held in the second storage unit 8, the obtainment unit 6 obtains, from the first storage unit 7, data included in a group to which the data corresponding to the data access request belongs, on the basis of the group management information. As one example of the obtainment unit 6, the input/output management unit 21 can be cited.

With such a configuration, a plurality of pieces of data can be managed in units of groups, and data can be obtained from the first storage unit in units of groups.

The partitioning unit 3 calculates the size of a reference group by using the number of pieces of data accessed in response to the data access request among data included in the selected group. Then, the partitioning unit 3 makes a comparison between the size of the selected group and the size of the reference group, and partitions a second group in accordance with a result of the comparison.

With such a configuration, an optimum group size is calculated by using the number of pieces of data accessed in response to a data access request, and a second group can be more suitably partitioned in accordance with a result of the comparison made between the size of a group to be written and the optimum group size.

The partitioning unit 3 may separate data of a size larger than the size of the reference group from the data included in the selected group, and may set the separated data as different groups.

With such a configuration, standalone data that exceeds the optimum group size among data included in a second group can be partitioned into groups including only the standalone data.

The partitioning unit 3 may separate the data accessed in response to the data access request among the data included in the selected group, and may merge the separated data into one group.

With such a configuration, it can be said that reused data has a closer relationship among data included in the same group held in the memory device. Therefore, these pieces of data are merged into one group, and are separated from data that is not reused. Thus, a group size can be reduced while maintaining a group that includes data having a close relationship.

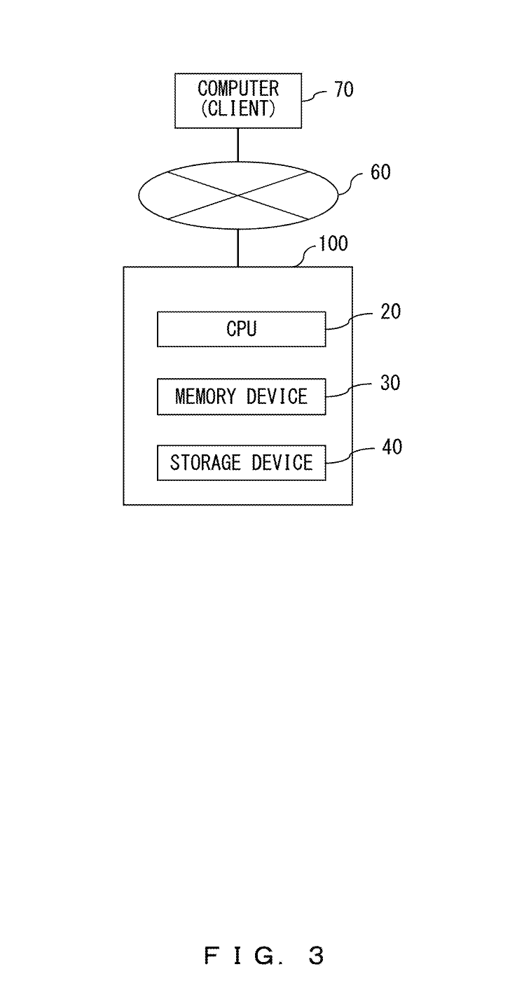

FIG. 3 illustrates an example of a hardware configuration of the data management apparatus according to this embodiment. The data management apparatus 100 includes, for example, a CPU (Central Processing Unit) 20, a memory device 30 and a storage device 40. Moreover, the data management apparatus 100 is connected to a client computer 70, which is one example of an information processing device, via a communication network 60 (hereinafter referred to simply as a network).

The CPU 20 is, for example, a processor that is an arithmetic processing unit including a program counter, an instruction decoder, various types of calculators, an LSU (Load Store Unit), a general-purpose register and the like.

The memory device 30 is a storage device that can be accessed faster than the storage device 40. Examples of the memory device 30 include a RAM (Random Access Memory), a flash memory and the like. Examples of the storage device 40 include an HDD (Hard Disk Drive) and the like.

In the storage device 40, data provided by the data management apparatus 100 is stored in units of groups. A group is a set of data having a relationship that is recognized to have a relationship on the basis of a history of access requests to data (hereinafter referred to as access requests), and content of the group is updated by a process executed by the CPU 20, as will be described later. The access requests include a READ request and a WRITE request.

In the memory device 30, for example, a group accessed with a high frequency among groups stored in the storage device 40 is read from the storage device 40 and stored. As a result, the data management apparatus 100 can quickly output data in response to an input access request.

The data management apparatus 100 includes a ROM that stores a BIOS (Basic Input/Output System), a program memory and the like in addition to the above described configuration. The program executed by the CPU 20 may be obtained via the communication network 60, or may be obtained by inserting, into the data management apparatus 100, a computer-readable portable recording medium such as a portable memory, a CD-ROM or the like.

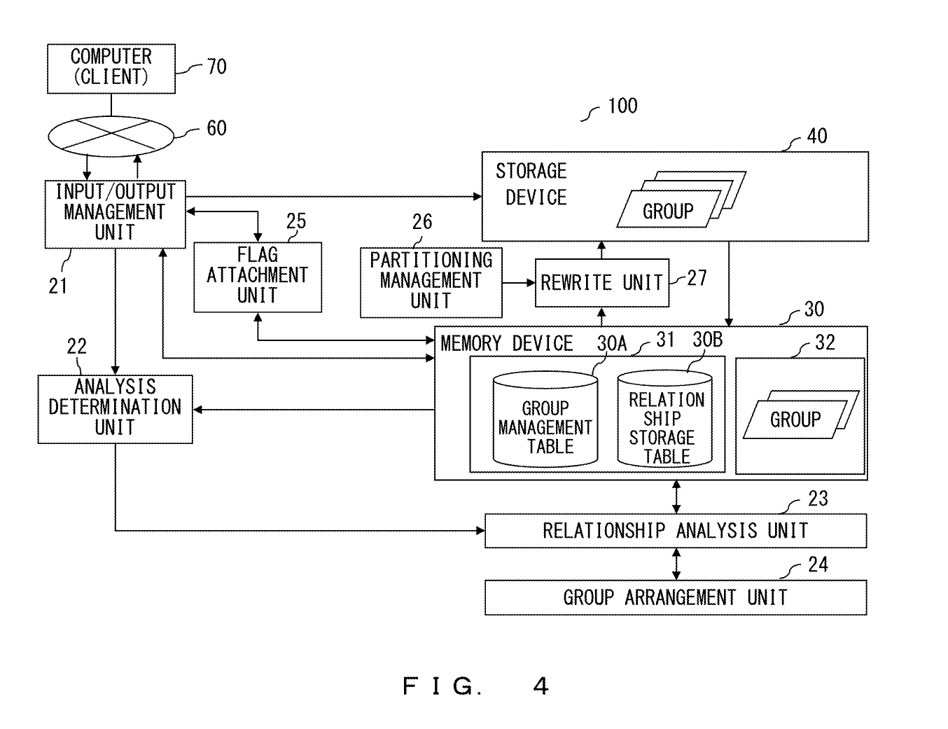

FIG. 4 illustrates a configuration example of functions of the data management apparatus according to this embodiment. The data management apparatus 100 includes the input/output management unit 21, an analysis determination unit 22, a relationship analysis unit 23, a group arrangement unit 24, a flag attachment unit 25, a partitioning management unit 26 and a rewrite unit 27 as functional units that function in such a way that the CPU 20 executes the program.

The memory device 30 includes a data storage area 32 for storing data read from the storage device 40, and a management area 31 for managing the read data. In the management area 31, a group management table 30A and a relationship storage table 30B are stored. The group management table 30A stores information for identifying a group to which data read into the memory device 30 belongs. The relationship storage table 30B is a table for accumulating and managing data for which a preceding access request has been made, for each piece of data for which an access request has been made. In the data storage area 32, data read from the storage device 40 in units of groups are stored.

The input/output management unit 21 searches the memory device 30 and the storage device 40 in response to an access request input from a request source such as the client computer 70 or the like, and transmits data corresponding to the access request to the request source. Note that an access request can be issued not only by the client computer 70 but also by an entity such as a process executed in the data management apparatus 100, or the like. Moreover, when an input/output device is connected to the data management apparatus 100, a user is also assumed to input an access request to the input/output device.

When an access request has been input, the input/output management unit 21 initially searches the memory device 30. When data targeted by the access request is held in the memory device 30, the input/output management unit 21 reads the data from the memory device 30, and returns the read data to the request source.

Alternatively, when the data targeted by the access request is not held in the memory device 30, the input/output management unit 21 searches the storage device 40. When the data targeted by the access request is stored in the storage device 40, the input/output management unit 21 reads, from the storage device 40, all the pieces of data included in a group to which the requested data belongs, by using the group management table 30A. Then, the input/output management unit 21 returns, to the request source, the requested data among all the pieces of data of the read group. At this time, the input/output management unit 21 stores all the pieces of data included in the read group from the storage device 40 to the memory device 30. When the input/output management unit 21 reads the data from the storage device 40 and stores the read data in the memory device 30, the input/output management unit 21 attaches a reuse flag to each piece of the read data, as will be described later.

The above provided description refers to the case where the input/output management unit 21 executes the process for storing, in the memory device 30, all the pieces of data included in the group read from the storage device 40 at the timing when an access request has been issued. However, the execution of the storage process is not limited to this one. For example, the input/output management unit 21 may obtain access frequencies for a specified duration, may read a group having a high access frequency from the storage device 40 with higher priority, and may store the group in the memory device 30.

The analysis determination unit 22 decides whether the relationship analysis unit 23 is to be caused to analyze a relationship by determining, with the use of the relationship storage table 30B, whether groups to which data to be accessed in response to consecutive access requests belong are the same group.

The relationship analysis unit 23 analyzes, in accordance with the relationship storage table 30B, a relationship between all the pieces of data of a group to which target data of the current access request belongs and all the pieces of data of a group to which target data of the preceding access request belong on the basis of results of the determination performed by the analysis determination unit 22. The relationship analysis unit 23 decides a group of the data on the basis of results of the analysis.

The group arrangement unit 24 updates the arrangement of groups in the group management table 30A in accordance with the decision made by the relationship analysis unit 23.

When data is read from the storage device 40 in units of groups and is stored in the memory device 30, the flag attachment unit 25 attaches a reuse flag (initial value=0) to each piece of the data. When data to be targeted by an access request is read from the memory device 30, the flag attachment unit 25 updates the reuse flag of the read data to 1.

When a group held in the memory device 30 is rewritten to the storage device 40, the partitioning management unit 26 counts the number of pieces of data (the number of reuses) to which the reuse flag set to 1 is attached within the group to be rewritten. At this time, the partitioning management unit 26 calculates an optimum group size by using the number of reuses, and a calculation formula to be described later. When the size of the group to be rewritten is larger than the optimum group size, the partitioning management unit 26 partitions the group to be rewritten into a plurality of groups. At this time, the partitioning management unit 26 erases the reuse flag from each of the pieces of data that belong to the group to be rewritten (including also the groups obtained by being partitioned). The partitioning management unit 26 updates information of an association between the data stored in the group management table 30A and a group in accordance with the partitioned groups.

The rewrite unit 27 rewrites, to the storage device 40, all the pieces of data that belong to a group for each group to be rewritten (including also the groups obtained by being partitioned).

Details of the contents of the processes executed by the analysis determination unit 22, the relationship analysis unit 23, the group arrangement unit 24, the flag attachment unit 25, the partitioning management unit 26 and the rewrite unit 27 will be described later.

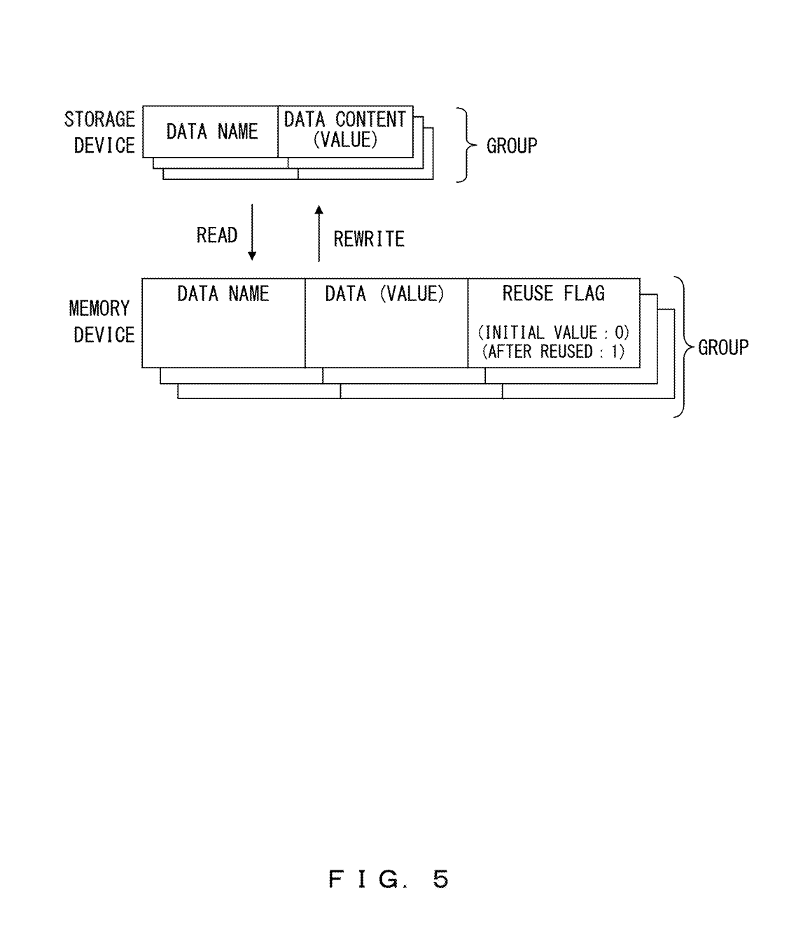

FIG. 5 is an explanatory diagram of a data structure. In the storage device 40, data includes a “data name” and “data content”. The “data name” is information for uniquely identifying data. The “data content” is content (value) of data identified with the “data name”.

When data designated by an access request is stored not in the memory device 30 but in the storage device 40, the input/output management unit 21 reads the data from the storage device 40, returns the read data to a request source, and stores the data in the memory device 30.

At this time, the flag attachment unit 25 attaches a reuse flag to the data read from the storage device 40, and stores the data in the memory device 30. An initial value of the attached reuse flag is “0”. When the input/output management unit 21 reads data from the memory device 30 if the data designated by an access request is held in the memory device 30, the flag attachment unit 25 updates, to “1”, the reuse flag attached to the read data in the memory device 30.

When data read from the storage device 40 for each group continues to be stored in the memory device 30 and the space of the memory device 30 becomes insufficient, the rewrite unit 27 rewrites a group to the storage device 40, in the order of less accessed groups. Namely, when the space of the memory device 30 becomes insufficient, the rewrite unit 27 selects a group, for example, with the LRU method, and rewrites data included in the selected group to the storage device 40. When data is rewritten from the memory device 30 to the storage device 40, the rewrite unit 27 rewrites the data to be rewritten after the partitioning management unit 26 deleted the reuse flag from the data to be rewritten.

States where data stored in the group management table 30A and the relationship storage table 30B vary in accordance with an access request input to the input/output management unit 21 are described next.

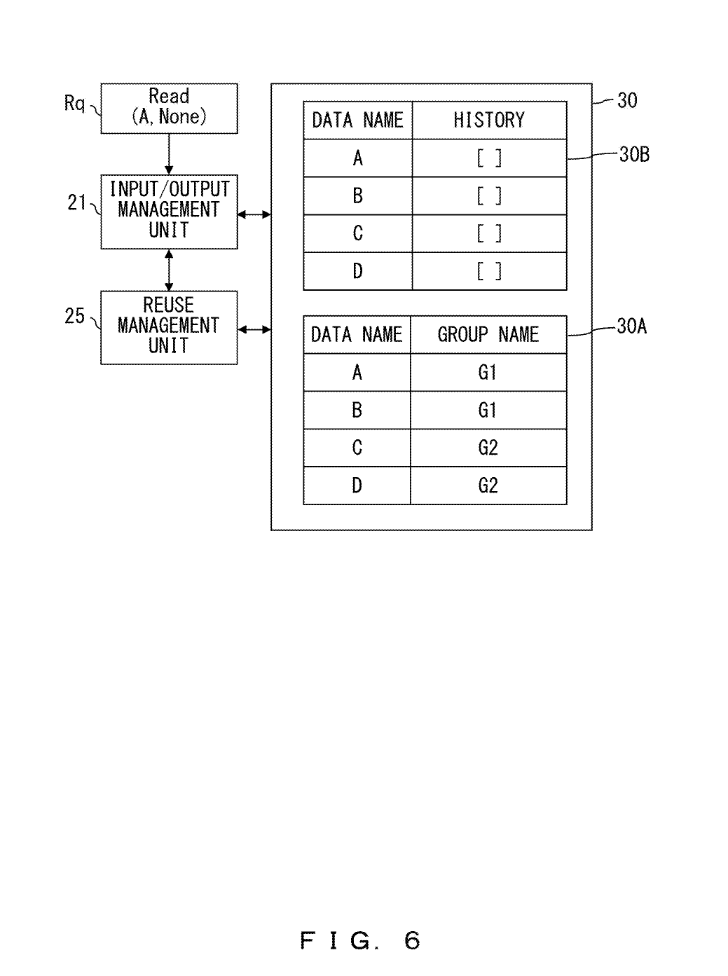

FIG. 6 illustrates the group management table and the relationship storage table when an access request Rq has been issued to the data management apparatus according to this embodiment. The access request Rq is indicated with Read(X,Y). The notation Read(X,Y) indicates that a target of the preceding access request is data Y and a target of the current access request is data X. Specifically, information with which the same request source can identify the target data Y of the preceding access request is assumed to be written in the access request Rq input to the data management apparatus 100. The information of the target data Y of the preceding access request may be grasped, for example, by the client computer 70 by itself, or may be grasped on the data management apparatus 100 side for each request source. In this case, the data management apparatus 100 stores a history of access requests for each request source in any of the memory device 30, a register and the like.

For explanatory purposes, data A to D are assumed to be stored in the memory device 30 in FIG. 6. At this time, a reuse flag “0” is also assumed to be attached respectively to the data A to D by the flag attachment unit 25.

In the state illustrated in FIG. 6, assume Read(A,None), namely, that an access request for the data A has been issued to the input/output management unit 21. In this case, the input/output management unit 21 reads the data A from the memory device 30, and outputs the read data to the request source. In this case, the flag attachment unit 25 updates, to “1”, the reuse flag of the data A held in the memory device 30.

Additionally, the input/output management unit 21 updates the relationship storage table 30B by referencing the information of target data of the preceding access request in the current access request. Here, as illustrated in FIG. 6, the access request is Read(A,None), and the preceding value is None, namely, the state where no data is present. Therefore, the input/output management unit 21 does not update the relationship storage table 30B.

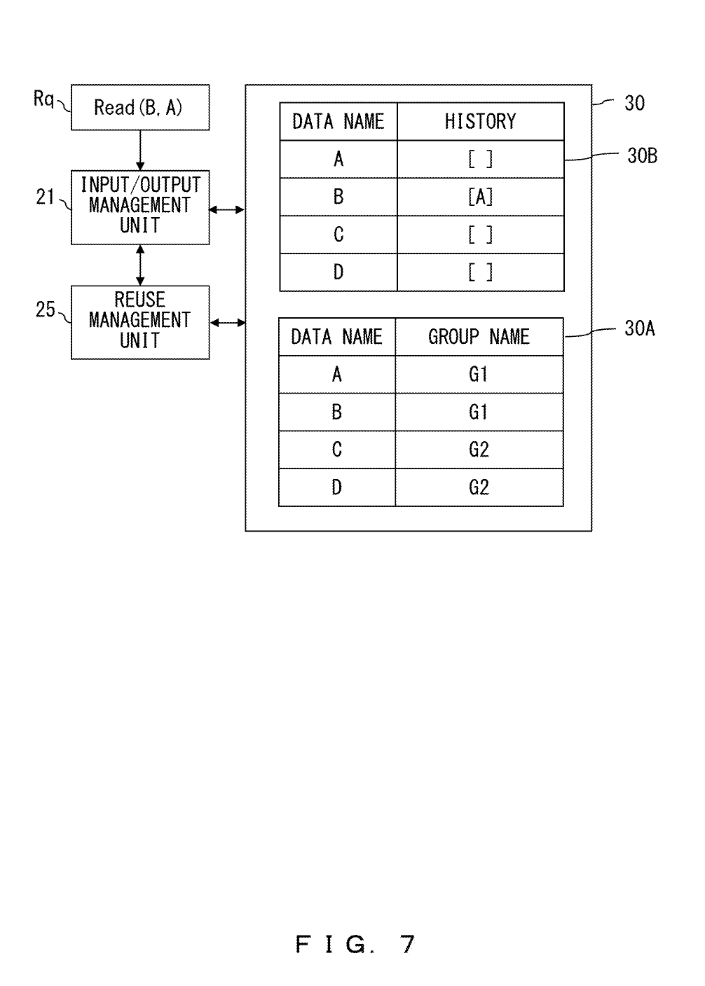

FIG. 7 illustrates the group management table and the relationship storage table when an access request Rq has been issued to the data management apparatus, subsequently to the state of FIG. 6. FIG. 7 assumes Read(B,A), namely, that the access request for the data B has been issued from the same request source as that of FIG. 6 (the same applies hereinafter) to the data management apparatus 100. The target of the preceding access request is the data A.

In this case, the input/output management unit 21 reads the data B from the memory device 30, and transmits the read data to the request source. At this time, the flag attachment unit 25 updates, to 1, the reuse flag of the data B held in the memory device 30.

Additionally, the input/output management unit 21 updates the relationship storage table 30B by referencing the target data of the preceding access request in the current access request. In the state illustrated in FIG. 7, the target data of the preceding access request is A in Read(B,A). Therefore, the input/output management unit 21 writes a value indicating the data A to an entry of the target data, namely, the data B of the current access request in the relationship storage table 30B.

When the relationship storage table 30B has been updated, the analysis determination unit 22 determines whether a relationship analysis performed by the relationship analysis unit 23 is needed in accordance with whether the target data of the current access request and the target data of the preceding access request belong to the same group. In the state illustrated in FIG. 7, the target data B of the current access request and the target data A of the preceding access request belong to the same group G1. Therefore, the analysis determination unit 22 determines that the relationship analysis is not needed.

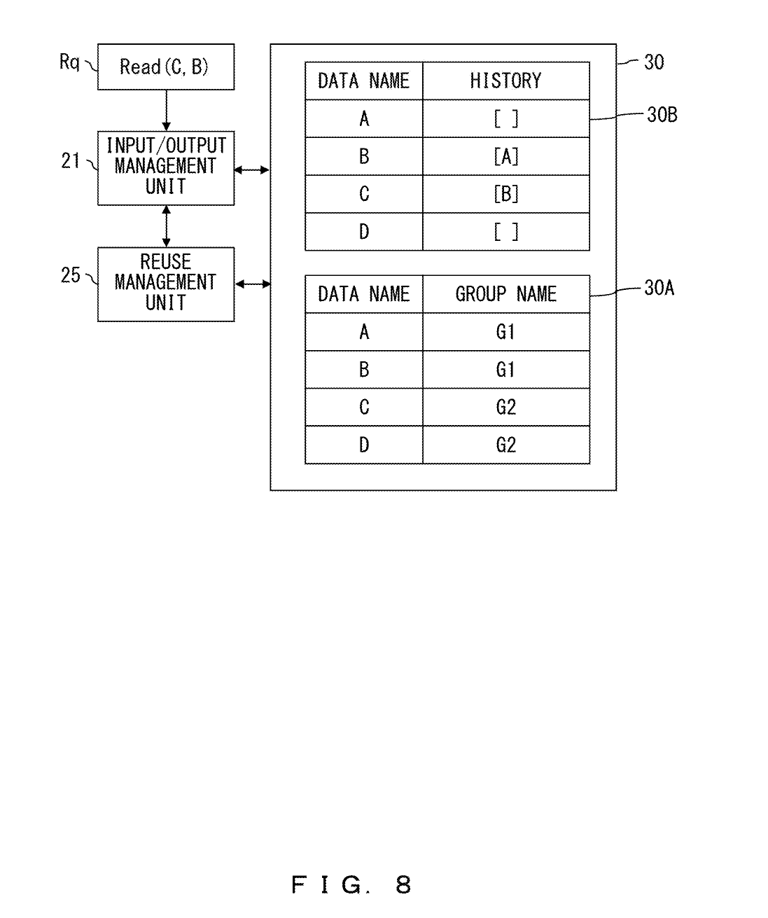

FIG. 8 illustrates the group management table and the relationship storage table when an access request Rq has been issued to the data management apparatus, subsequently to the state of FIG. 7. FIG. 7 assumes Read(C,B), namely, that a request to read the data C has been issued to the data management apparatus 100. The target data of the preceding access request is B.

The input/output management unit 21 reads the data C from the memory device 30, and transmits the read data to the request source. In this case, the flag attachment unit 25 updates, to 1, the reuse flag of the data B held in the memory device 30.

Additionally, the input/output management unit 21 updates the relationship storage table 30B by referencing the target data of the preceding access request. In the state illustrated in FIG. 8, the target data of the preceding access request is B. Therefore, the input/output management unit 21 writes the value indicating the data B once to an entry of the target data, namely, the data C of the current access request in the relationship storage table 30B.

When the relationship storage table 30B has been updated, the analysis determination unit 22 determines whether a relationship analysis performed by the relationship analysis unit 23 is needed in accordance with whether the target data of the current access request and the target data of the preceding access request belong to the same group. In the state illustrated in FIG. 8, the target data C of the current access request and the target data B of the preceding access request belong to the different groups. Therefore, the analysis determination unit 22 determines that the relationship analysis is needed.

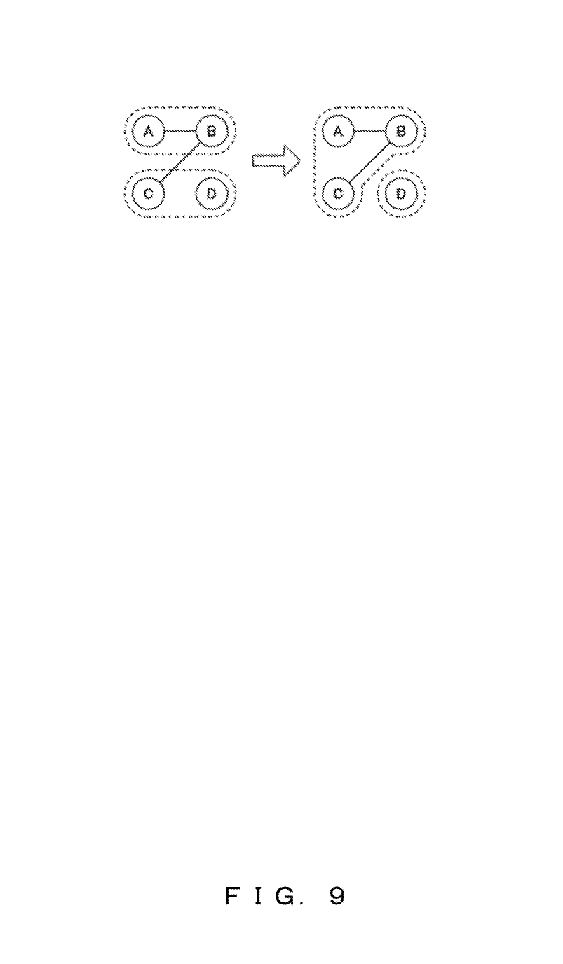

The relationship analysis unit 23 analyzes a relationship between data, for example, by using a graph partitioning technique. The process of the relationship analysis unit 23 is described with reference to FIG. 9.

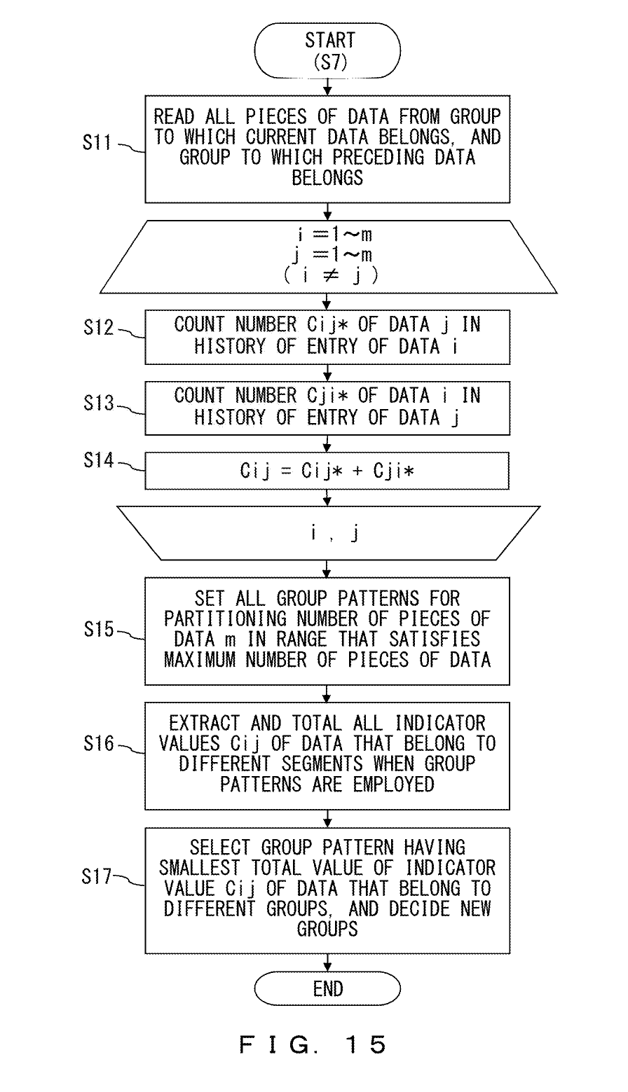

FIG. 9 illustrates group arrangements before and after the relationship analysis unit 23 changes groups in the state illustrated in FIG. 8. In FIG. 9, a root side of an arrow indicates a group before being changed, while a tip side of the arrow indicates a group after being changed. In FIG. 9, the number of solid lines that link the data A, B and the like is equivalent to an indicator value Cij to be described with reference to FIG. 15, and dashed lines respectively indicate a line of demarcation between groups. A “total of indicator values Cij of pairs of data that belong to different groups”, which is to be described with reference to FIG. 15, is equivalent to the number of linking lines disconnected when the indicator value Cij is regarded as the number of virtually linking lines.

In the case of FIG. 9, it is proved that the number of solid lines disconnected by a line of demarcation between a group {A,B,C} and a group {D} is 0, and that a total of indicator values Cij in this grouping is 0.

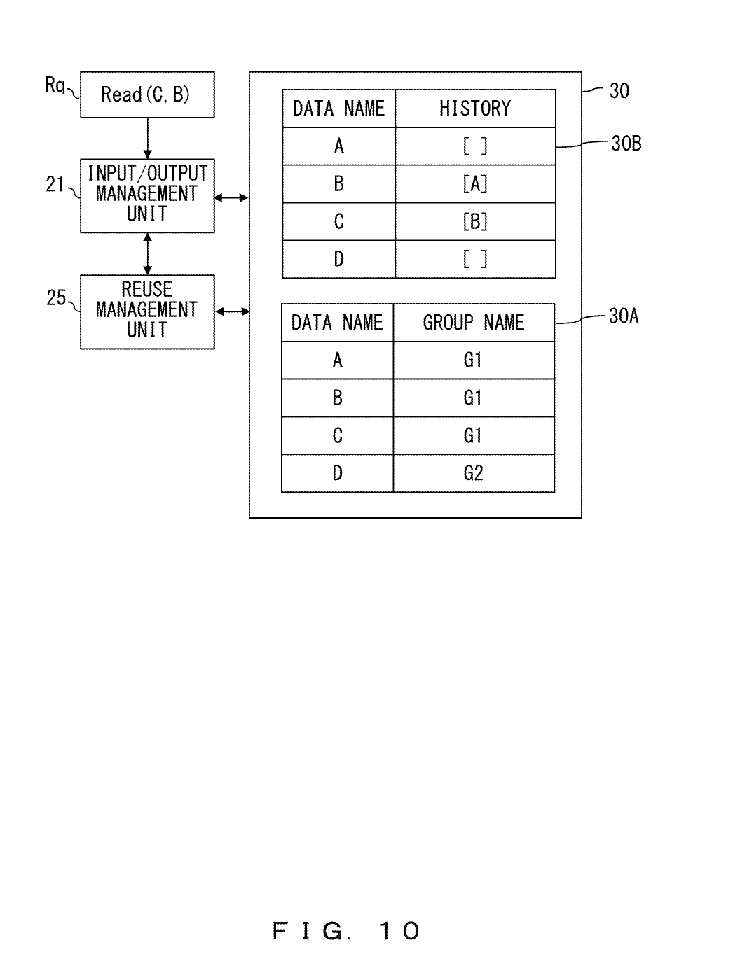

When the relationship analysis unit 23 has decided new groups, the group arrangement unit 24 changes an association between the data of the group management table 30A and a group. This is described with reference to FIG. 10.

FIG. 10 illustrates associations between data and a group in the group management table after being changed by the group arrangement unit. Compared with FIG. 8, the group to which the data C belongs changes from G2 to G1 in the group management table 30A in FIG. 10.

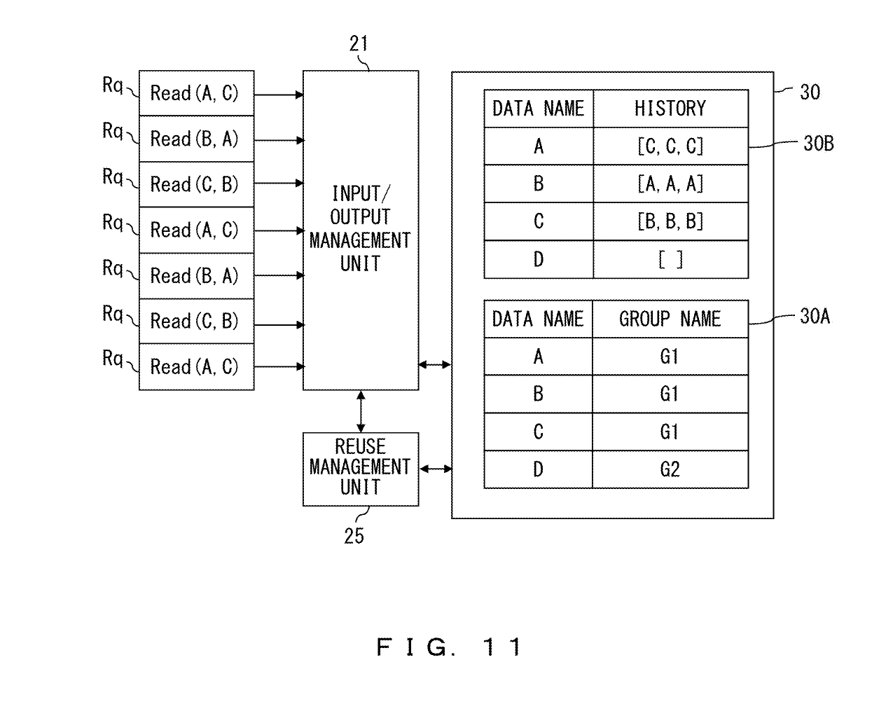

FIG. 11 illustrates the group management table and the relationship storage table when a plurality of access requests Rq have been issued to the data management apparatus a plurality of times, subsequently to the state of FIG. 10. The target data of the current access request and the target data of the preceding access request belong to the same group in all the access requests Rq illustrated in FIG. 11. Therefore, a relationship analysis and a change in an association between data and a group are not performed even though the relationship storage table 30B has been updated.

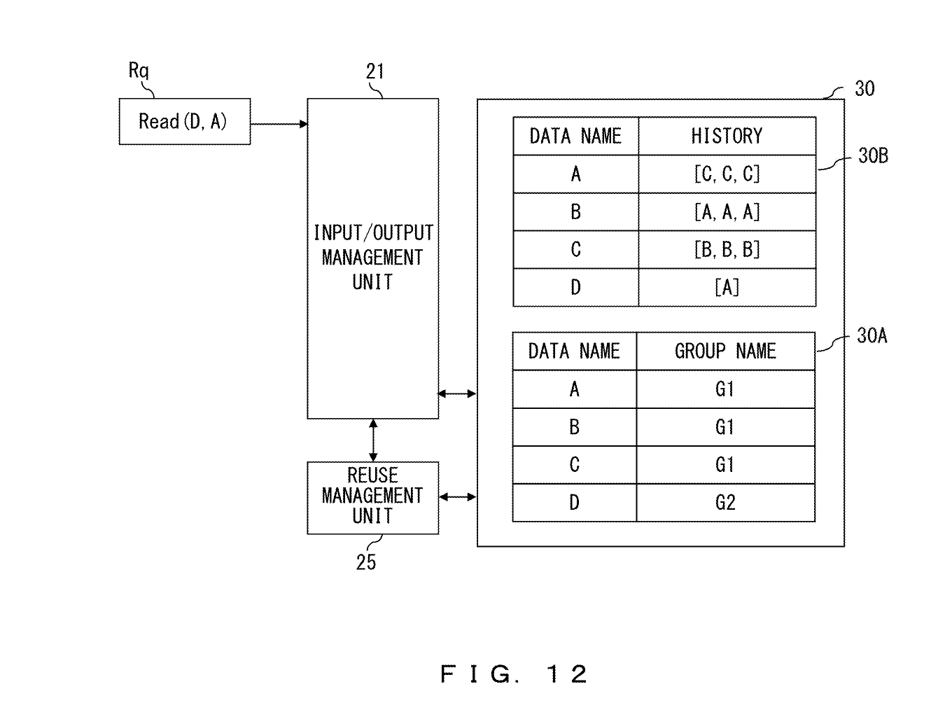

FIG. 12 illustrates the group management table and the relationship storage table when an access request Rq has been issued to the data management apparatus, subsequently to the state of FIG. 11. Since the target data D of the current access request and the target data A of the preceding access request belong to the different groups, the analysis determination unit 22 determines that a relationship analysis is needed in this state. At this time, the flag attachment unit 25 updates, to 1, the reuse flag of the data D held in the memory device 30.

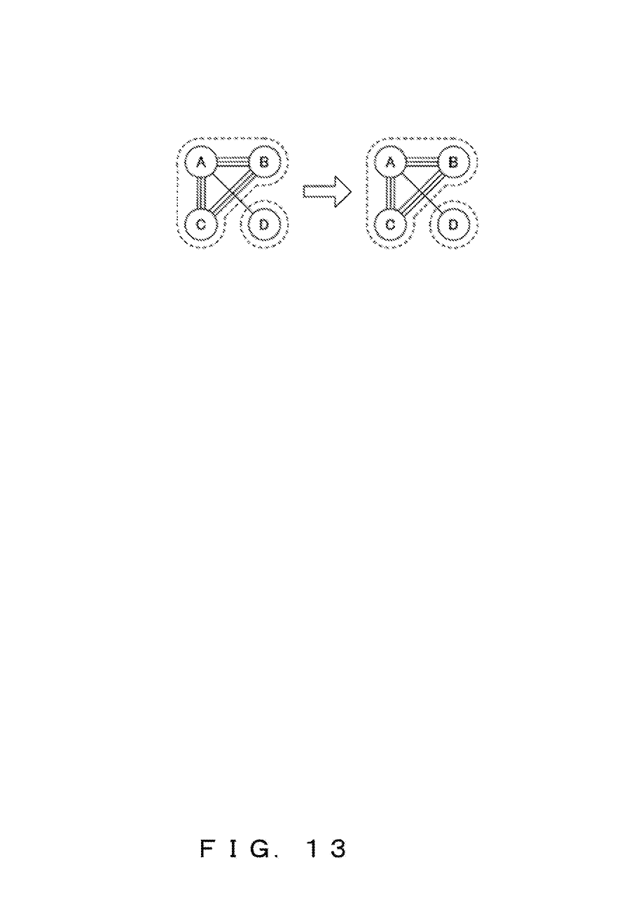

In the state of FIG. 12, a plurality of history records between the data A, B and C are already accumulated in the relationship storage table 30B. Accordingly, as will be described with reference to FIG. 15, indicator values Cij between A and B, between A and C, and between B and C are calculated to be relatively large, and an indicator value Cij between A and D is calculated to be relatively small. Therefore, the relationship analysis unit 23 does not change the associations between data and a group as illustrated in FIG. 13.

FIG. 13 illustrates group arrangements before and after the relationship analysis unit decides groups in the state of FIG. 12. In the case of FIG. 12, the indicator values Cij between A and B, between A and C, and between B and C are respectively 3, while the indicator value Cij between A and D is 1. Accordingly, relationships between A and B, between A and C, and between B and C are closer than that between A and D. Therefore, the groups are not rearranged.

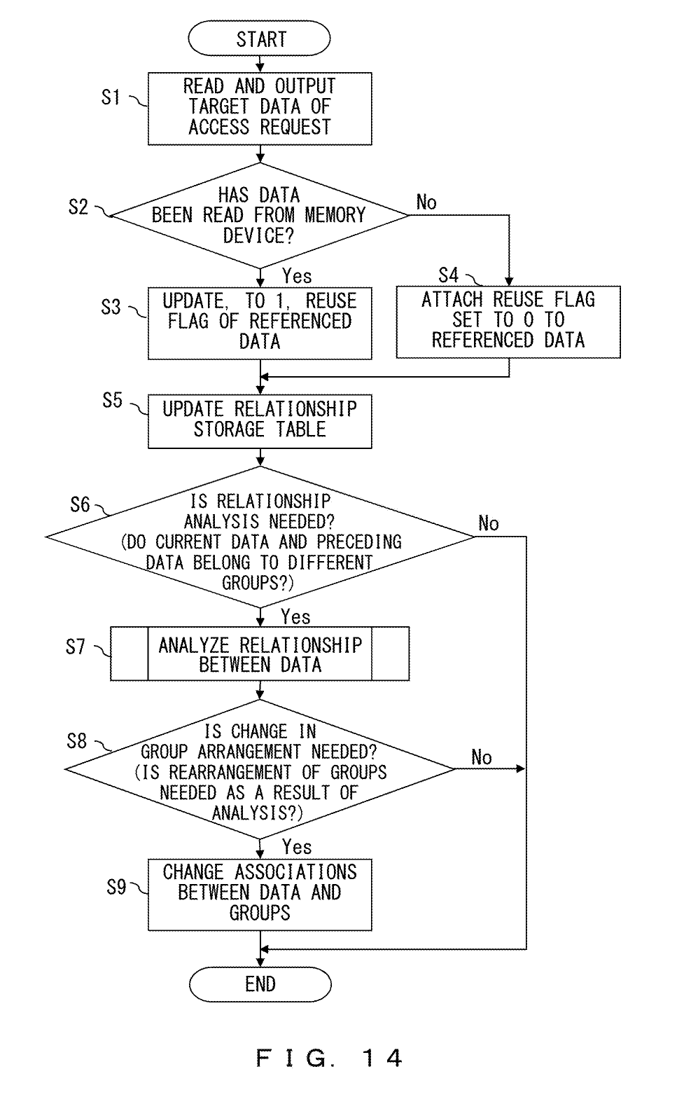

FIG. 14 is one example of a flowchart that represents a flow of a process executed by the data management apparatus according to this embodiment when an access request has been issued. The process of this flowchart is executed each time an access request has been issued to the data management apparatus 100.

Initially, the input/output management unit 21 reads target data of the access request from the memory device 30 or the storage device 40, and transmits the read data to the request source (S1). When the target data of the access request is not held in the memory device 30 at this time, the input/output management unit 21 reads, from the storage device 40, all the pieces of data of the group to which the target data of the access request belongs by using the group management table 30A (“NO” in S2). Then, the input/output management unit 21 transmits the target data of the access request among all the pieces of read data of the group. At this time, the flag attachment unit 25 attaches a reuse flag=0 to the data read from the storage device 40, and stores, in the memory device 30, the data to which the reuse flag=0 is attached (S4).

Alternatively, when the target data of the access request is held in the memory device 30 (“YES” in S2), the flag attachment unit 25 attaches the reuse flag=1 to the target data (S3).

Next, the input/output management unit 21 updates the relationship storage table 30B by referencing the target data of the preceding access request included in the access request (S5).

When the relationship storage table 30B has been updated, the analysis determination unit 22 determines whether a relationship analysis performed by the relationship analysis unit 23 is needed, namely, whether the target data of the current access request and the target data of the preceding access request belong to different groups (S6). When the analysis determination unit 22 determines that the relationship analysis is not needed, namely, when the target data of the current access request and the target data of the preceding access request belong to the same group (“NO” in S6), the data management apparatus 100 terminates the process of this flowchart.

When the analysis determination unit 22 determines that the relationship analysis is needed, namely, when the target data of the current access request and the target data of the preceding access request belong to different groups (“YES” in S6), the relationship analysis unit 23 analyzes a relationship between the data (S7). Details of the process of S7 will be described later with reference to FIG. 15.

Next, the group arrangement unit 24 determines whether a change in an association between data and a group is needed, namely, whether it is needed to rearrange the groups on the basis of results of the analysis performed by the relationship analysis unit 23 (S8). When the group arrangement unit 24 determines that the change in the association between data and a group is not needed (“NO” in S8), the data management apparatus 100 terminates the process of this flowchart.

When the group arrangement unit 24 determines that the change in the association between data and a group is needed (“YES” in S8), the group arrangement unit 24 changes the association between data and a group in the group management table 30A as described above with reference to FIG. 10 (S9).

FIG. 15 is one example of a flowchart that represents a flow of the relationship analysis process (S7) executed by the relationship analysis unit.

Initially, the relationship analysis unit 23 reads all the pieces of data included in both a group to which the target data of the current access request belongs and a group to which the target data of the preceding access request belongs (S11).

Next, the relationship analysis unit 23 executes the process of S12 to S14 by extracting two pieces of data i,j from the read data for all the pairs of i,j (i≠j). In FIG. 15, m is the number of types of data read in S11.

The relationship analysis unit 23 counts the number Cij* of pieces of data j in a history of an entry of the data i stored in the relationship storage table 30B (S12). Next, the relationship analysis unit 23 counts the number Cji* of the data i in a history of an entry of the data j stored in the relationship storage table 30B (S13).

Next, the relationship analysis unit 23 calculates an indicator value Cij that indicates a relationship between the data i and j by adding Cij* and Cji* (S14). In the case of FIG. 8, C_{AB}=1, C_{AC}=0, C_{AD}=0, C_{BC}=1, C_{BD}=0, and C_{CD}=0 are obtained.

After the relationship analysis unit 23 has executed the process of S12 to S14 for all the pieces of data i,j, it sets all the group patterns for partitioning the number m of pieces of data within a range that satisfies a maximum number (such as 3) of pieces of data within a group (S15). The example of FIG. 8 assumes that the number of pieces of data is 4 (data A to D) and the maximum number of pieces of data is 3. At this time, the group patterns are four patterns such as ((ABC) (D), (BCD) (A), (CDA) (B), (ABD) (C)) when the groups are partitioned at a ratio of 3:1. Alternatively, the group patterns are six patterns such as ((AB) (CD), (AC) (BD), (AD) (BC), (BC) (AD), (BD) (AC), (CD) (AB)) when the groups are divided at a ratio of 2:2. In this way, the ten group patterns are set in total.

Next, the relationship analysis unit 23 extracts and totals all the indicator values Cij of the data that belong to different groups when the group patterns are respectively employed (S16).

Then, the relationship analysis unit 23 selects a group pattern having the smallest total of the indicator values Cij for the pairs of data that belong to different groups, and decides new groups (S17). In the case of FIG. 8, the new groups are as follows.

(ABC) (D):C_{AD}+C_{BD}+C_{CD}=0

(BCD) (A):C_{AB}+C_{AC}+C_{AD}=1

(CDA) (B):C_{AB}+C_{BC}+C_{BD}=2

(ABD) (C):C_{AC}+C_{BC}+C_{CD}=1

(AB) (CD):C_{AC}+C_{AD}+C_{BC}+C_{BD}=1

(AC) (BD):C_{AB}+C_{AD}+C_{BC}+C_{CD}=2

(AD) (BC):C_{AD}+C_{AC}+C_{BD}+C_{CD}=1

(BC) (AD):C_{AB}+C_{BD}+C_{AC}+C_{CD}=1

(BD) (AC):C_{AB}+C_{BC}+C_{AD}+C_{CD}=2

(CD) (AB):C_{AC}+C_{BC}+C_{AD}+C_{BD}=1

As a result, the total of the indicator values Cij of the group pattern of the groups (ABC) and (D) is calculated to be 0, and becomes smallest. Therefore, the relationship analysis unit 23 decides this group pattern (ABC) (D) to be the new groups.

A group partitioning process executed when data is rewritten from the memory device 30 to the storage device 40 is described next.

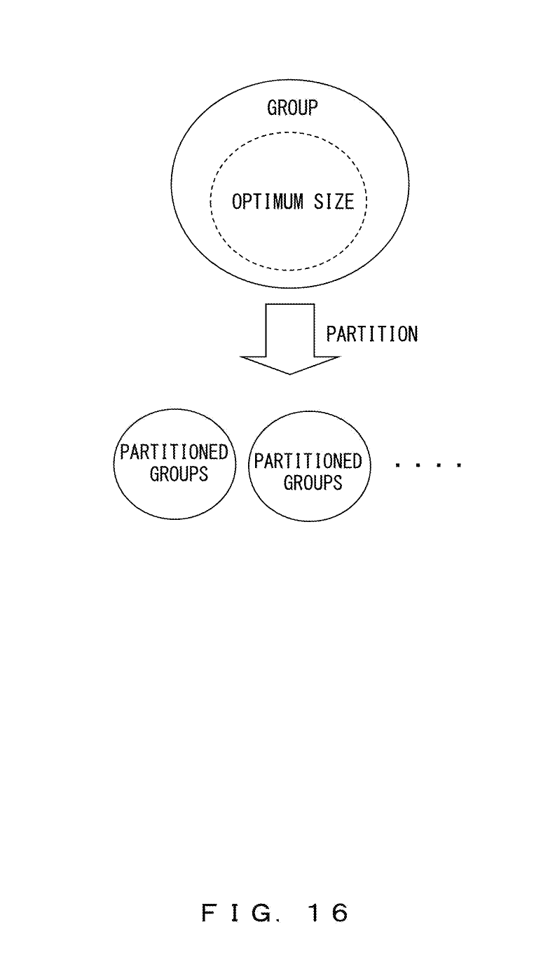

FIG. 16 is an explanatory diagram of a process for partitioning a group to be rewritten in accordance with the size of the group to be rewritten when data is rewritten from the memory device 30 to the storage device 40 in this embodiment.

If the size of a group to be rewritten is larger than an optimum group size when data is rewritten from the memory device 30 to the storage device 40, the partitioning management unit 26 partitions the group to be rewritten. In this case, the rewrite unit 27 rewrites, to the storage device 40, all the groups to be rewritten (including also groups obtained by being partitioned). The optimum group size will be described later.

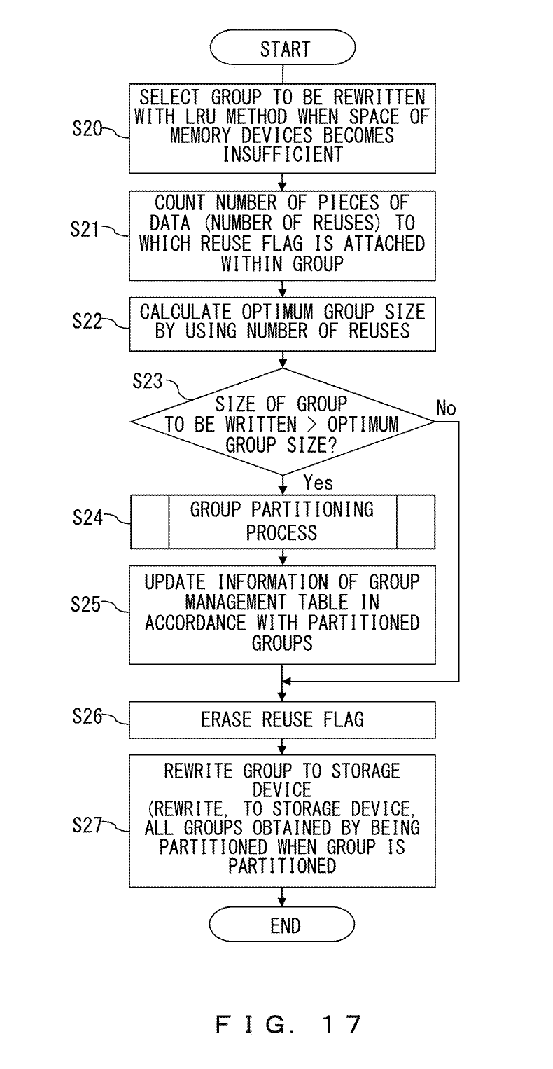

FIG. 17 illustrates a flow of a process executed when any of the groups held in the memory device is rewritten to the storage device in this embodiment.

When the space of the memory device 30 becomes insufficient, the input/output management unit 21 executes the following process. The case where the space of the memory device 30 becomes insufficient is, for example, a case where the space of the memory device 30 becomes insufficient when an attempt is made to store a group read from the storage device 40 in the memory device 30, or a case where data that exceeds a preset threshold value is stored in the memory device 30. In such a case, the input/output management unit 21 selects, as a group to be written, any of the groups held in the memory device 30 (S20). Here, any of the groups is, for example, a group decided with the LRU method, namely, the least recently accessed group.

The partitioning management unit 26 calculates the number of pieces of data (the number of reuses) to which a reuse flag is attached in the selected group to be written (S21).

The partitioning management unit 26 calculates an optimum group size on the basis of the number of reuses by using the following formula (1) (S22). Here, the following formula for calculating an optimum group size is described. The number of reuses is indicated with u. The optimum group size is indicated with s. The following parameters are parameters used to calculate the optimum group size. A cost a of a random access and a cost b of a sequential access are preset in the storage device.

cost of a random access: a[ms]

cost of a sequential access: b[MB/s]=b[KB/s]

total of sizes of data having a reuse flag set to 1:d

At this time, a cost C₁ needed with the LRU is represented as C₁=ua+d/b. Moreover, a cost that comes with the DLM is represented as Ca=a+s/b. Here, C₁>Cₐ is demanded. Therefore, the optimum group size is represented as follows.

S<(u−1)ab+d (1)

The partitioning management unit 26 determines whether the size of the group to be written is larger than the optimum group size (S23). When the size of the group to be written is equal to or smaller than the optimum group size (“NO” in S23), the flow proceeds to the process of S26.

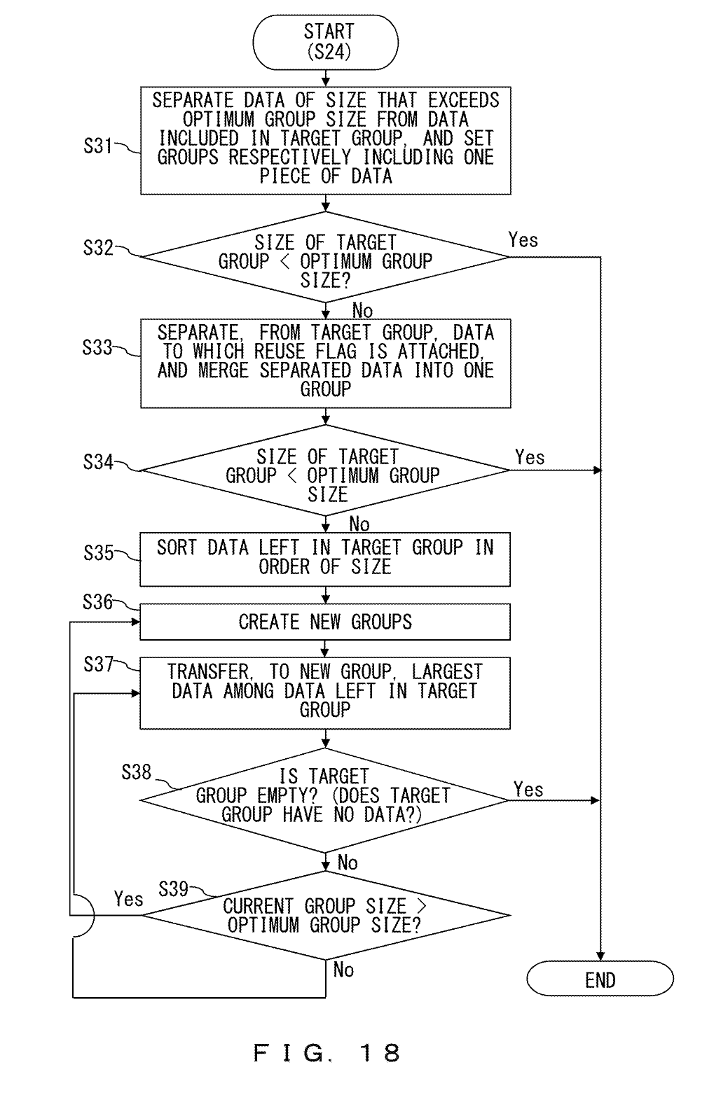

When the size of the group to be written is larger than the optimum group size (“YES” in S23), the partitioning management unit 26 executes the group partitioning process (S24). Here, the partitioning management unit 26 partitions the current group so that the size of the group to be written can become smaller than the optimum group size, and also partitions the groups obtained by being partitioned so that the size of the groups can become smaller than the optimum group size. Details of the process of S25 will be described later with reference to FIG. 18.

The partitioning management unit 26 updates the information of the group management table 30A in accordance with the groups partitioned in S24 (S25).

The partitioning management unit 26 deletes the data item of the reuse flag from all the pieces of data included in the group to be written (S26). When the group to be written is partitioned into a plurality of groups at this time, the rewrite unit 27 deletes the data item of the reuse flag from all the pieces of data included in all the groups obtained by being partitioned.

The rewrite unit 27 rewrites the group to be written to the storage device. When the group to be written is partitioned into a plurality of groups at this time, the rewrite unit 27 rewrites all the groups obtained by being partitioned to the storage device (S27).

FIG. 18 illustrates a flow of the details of the group partitioning process S24 executed in this embodiment. In the following description, a group to be written, a base of partitioning, is referred to as a “target group”. The partitioning management unit 26 separates, from the target group, one or more pieces of data having a data size that exceeds the optimum group size, and sets the separated data as groups that respectively include only one piece of the data (S31).

The partitioning management unit 26 determines whether the size of the target group is smaller than the optimum group size (S32). When the size of the target group is smaller than the optimum group size (“YES” in step S32), this flow is terminated.

When the size of the target group is equal to or larger than the optimum group size (“NO” in S32), the partitioning management unit 26 separates, from the target group, data having the reuse flag set to 1, and merges the separated data into one group (S33).

The partitioning management unit 26 again determines whether the size of the target group is smaller than the optimum group size (S34). When the size of the target group is smaller than the optimum group size (“YES” in S34), this flow is terminated.

When the size of the target group is equal to or larger than the optimum group size (“NO” in S32), the partitioning management unit 26 sorts data left in the target group in the order of size (increasing or decreasing order of size) (S35).

The partitioning management unit 26 creates a new group (S36). The partitioning management unit 26 transfers, to the new group, the largest data among the data left in the target group (S37).

The partitioning management unit 26 determines whether the target group is empty, namely, whether data is still left in the target group (S38). When the target group is empty (“YES” in S38), this flow is terminated.

When the target group is not empty (“NO” in S38), the partitioning management unit 26 determines whether the size of the target group is larger than the optimum group size (S39).

When the size of the target group is larger than the optimum group size (“YES” in S39), the flow returns to S37. When the size of the target group is equal to or smaller than the optimum group size (“NO” in S39), the flow returns to the process of S36.

According to this embodiment, an optimum group size is calculated on the basis of the number of reuses, and a group is partitioned so that the size of partitioned groups can become equal to or smaller than the optimum group size. As a result, a mismatch between the number of reuses and a group size can be prevented, and the performance of DLM can also be prevented from being degraded.

By partitioning a group size when needed, a performance degradation caused by too large a group size can be prevented. Moreover, no restrictions are imposed on a rearrangement algorithm, so that a group size does not become too small. A group size can be reduced only when the performance implemented with the DLM can be degraded with a high probability.

A group is partitioned by using a method independent of a rearrangement algorithm when the group is rewritten to a disk on the basis of quantitatively observed data. This also eliminates the need for using an advanced rearrangement algorithm.

Since an upper limit of a group size is not set, flexible grouping (rearrangement) can still be performed. Immediately recently accessed data (data having a close relationship) is not partitioned.

The present invention is not limited to the above described embodiments, and various configurations or embodiments can be employed within a scope that does not depart from the gist of the present invention.

According to the present invention, an access performance degradation caused by an increase in the size of a write to a storage unit can be prevented.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data storing control apparatus comprising:
a processor which executes a process including:
selecting any of groups stored in a second storage unit when an empty space of the second storage unit configured to store data obtained from a first storage unit becomes insufficient;
partitioning the selected group in accordance with a state of access to data corresponding to a data access request in the second storage unit among data included in the selected group; and
storing data respectively included in the groups in the first storage unit in units of the groups obtained by being partitioned.

2. The data storing control apparatus according to claim 1, the process further including:
updating group management information that makes an association between the data and the group on the basis of a result of the partitioning; and
obtaining, from the first storage unit, data included in a group to which the data corresponding to the data access request belongs, on the basis of the group management information when the data corresponding to the data access request is not held in the second storage unit.

3. The data storing control apparatus according to claim 1, wherein
the partitioning includes:
calculating a size of a reference group by using the number of pieces of data accessed in response to data access requests among the data included in the selected group;
making a comparison between a size of the selected group and the size of the reference group; and
partitioning the selected group in accordance with a result of the comparison.

4. The data storing control apparatus according to claim 1, wherein
the partitioning includes:
separating data of a size larger than a size of a reference group from the data included in the selected group; and
setting the separated data as different groups.

5. The data storing control apparatus according to claim 1, wherein
the partitioning includes:
separating data accessed in response to the data access request among the data included in the selected group; and
merging the separated data into one group.

6. A non-transitory computer-readable recording medium having stored therein a program for causing a computer to execute a process for controlling storing of data, the process comprising:
selecting any of groups stored in a second storage unit when an empty space of the second storage unit configured to store data obtained from a first storage unit becomes insufficient;
partitioning the selected group in accordance with a state of access to data corresponding to a data access request in the second storage unit among data included in the selected group; and
storing data respectively included in the groups in the first storage unit in units of the groups obtained by being partitioned.

7. The non-transitory computer-readable recording medium according to claim 6, the process further comprising:
updating group management information that makes an association between the data and the group on the basis of a result of the partitioning; and
obtaining, from the first storage unit, data included in a group to which the data corresponding to the data access request belongs, on the basis of the group management information when the data corresponding to the data access request is not held in the second storage unit.

8. The non-transitory computer-readable recording medium according to claim 6, wherein
the partitioning includes:
calculating a size of a reference group by using the number of pieces of data accessed in response to data access requests among the data included in the selected group;
making a comparison between a size of the selected group and the size of the reference group; and
partitioning the second group in accordance with a result of the comparison.

9. The non-transitory computer-readable recording medium according to claim 6, wherein
the partitioning includes:
separating data of a size larger than a size of a reference group from the data included in the selected group; and
setting the separated data as different groups.

10. The non-transitory computer-readable recording medium according to claim 6, wherein
the partitioning includes:
separating data accessed in response to the data access request among the data included in the selected group; and
merging the separated data into one group.

11. A data storing control method comprising:
selecting, by using a computer, a second group, which is any of groups stored in a second storage unit when an empty space of the second storage unit configured to store data obtained from a first storage unit becomes insufficient;
partitioning, by using the computer, the selected group in accordance with a state of access to data corresponding to a data access request in the second storage unit among data included in the selected group; and
storing, by using the computer, data respectively included in the groups in the first storage unit in units of the groups obtained by being partitioned.

12. The data storing control method according to claim 11, further comprising:
updating, by using the computer, group management information that makes an association between the data and the group on the basis of a result of the partitioning; and
obtaining, from the first storage unit, data included in a group to which the data corresponding to the data access request belongs, by using the computer, on the basis of the group management information when the data corresponding to the data access request is not held in the second storage unit.

13. The data storing control method according to claim 11, wherein
the partitioning includes:
calculating a size of a reference group by using the number of pieces of data accessed in response to data access requests among the data included in the selected group;
making a comparison between a size of the selected group and the size of the reference group; and
partitioning the second group in accordance with a result of the comparison.

14. The data storing control method according to claim 11, wherein
the partitioning includes:
separating data of a size larger than a size of a reference group from the data included in the selected group; and
setting the separated data as different groups.

15. The data storing control method according to claim 11, wherein
the partitioning includes:
separating data accessed in response to the data access request among the data included in the selected group; and
merging the separated data into one group.
